(19) United States
(12) Patent Application Publication
(10) Pub. No.: US 2022/0299803 A1
(43) Pub. Date: Sep. 22, 2022

(54) OPTICAL DEVICE, OPTICAL COMMUNICATION APPARATUS, AND METHOD OF MANUFACTURING THE OPTICAL DEVICE

(71) Applicant: Fujitsu Optical Components Limited, Kawasaki-shi (JP)

(72) Inventor: Masaki Sugiyama, Kawasaki (JP)

(73) Assignee: Fujitsu Optical Components Limited, Kawasaki-shi (JP)

(21) Appl. No.: 17/669,842

(22) Filed: Feb. 11, 2022

(30) Foreign Application Priority Data
Mar. 16, 2021 (JP) 2021-042906

(51) Int. Cl. G02F 1/035; H04B 10/50

(52) U.S. Cl. CPC G02F 1/0356; H04B 10/501; G02F 2202/20

(57) ABSTRACT

An optical device includes an optical waveguide that is a projected section and that is disposed at a predetermined portion on a thin film substrate, a buffer layer that is formed on the thin film substrate and the optical waveguide, and an electrode that is formed on the buffer layer and that applies a voltage to the optical waveguide. The electrode covers a step portion of the buffer layer formed on side walls of the optical waveguide.

### CROSS-REFERENCE TO RELATED APPLICATION

This application is based upon and claims the benefit of priority of the prior Japanese Patent Application No. 2021-042906, filed on Mar. 16, 2021, the entire contents of which are incorporated herein by reference.

### FIELD

The embodiments discussed herein are related to an optical device, an optical communication apparatus, and a method of manufacturing the optical device.

### BACKGROUND

In general, for example, an optical device, such as an optical modulator, includes an optical modulator chip in which an optical waveguide is formed on the surface of the optical modulator chip. A signal electrode is disposed on the optical waveguide that is formed on the optical modulator chip and, if a voltage is applied to the signal electrode, an electric field in a vertical direction with respect to the surface of the optical modulator chip is generated inside the optical waveguide. The refractive index of the optical waveguide varies due to the electric field; therefore, the phase of light propagating in the optical waveguide is changed and it is thus possible to modulate the light. Namely, the optical waveguide formed on the optical modulator chip constitutes, for example, a Mach-Zehnder interferometer and is able to output, for example, IQ signals that are subjected to XY polarization division multiplexing on the basis of phase differences of the light between a plurality of optical waveguides that are disposed in parallel.

If the optical modulator chip performs high-speed modulation, a high-speed signal with a band of, for example, several tens of gigahertz (GHz) is input to a signal electrode that is disposed along the optical waveguide. Consequently, a coplanar waveguide (CPW) structure that is able to obtain a wide band transmission characteristic is sometimes used for the signal electrode. Namely, a signal electrode and a pair of ground electrodes that sandwiches the signal electrode are sometimes disposed on an upper side of the optical waveguide.

In contrast, the optical waveguide is sometimes formed at a position that does not overlap with a position of the signal electrode by spreading, for example, metals, such as titanium, from the surface of a substrate. Furthermore, a thin film optical waveguide using a thin film made of a lithium niobate (LN) crystal is sometimes formed at the position that does not overlap with the position of the signal electrode. A thin film optical waveguide is able to confine light more strongly as compared to when a diffusion optical waveguide that diffuses metal is used, is able to improve an application efficiency of the electric field, and is able to decrease a drive voltage.

FIG. 14 is a schematic cross-sectional view illustrating an example of a DC electrode included in an optical modulator. A direct current (DC) electrode 200 illustrated in FIG. 14 includes a support substrate 201 made of silicon (Si) or the like, and an intermediate layer 202 that is laminated on the support substrate 201. Furthermore, the DC electrode 200 includes a thin film LN substrate 203 that is laminated on the intermediate layer 202, and a buffer layer 204 that is made of SiO₂ and that is laminated on the thin film LN substrate 203.

A thin film optical waveguide 207 that has a convex shape and that protrudes upward is formed on the thin film LN substrate 203. Then, the thin film LN substrate 203 and the thin film optical waveguide 207 are covered by the buffer layer 204, and a signal electrode 205 and a pair of ground electrodes 206 having a coplanar structure are disposed on the surface of the buffer layer 204. Namely, the signal electrode 205 and the pair of the ground electrodes 206 that sandwich the signal electrode 205 are disposed on the buffer layer 204.

The thin film optical waveguide 207 having a convex shape is formed on the thin film LN substrate 203 at a position between the signal electrode 205 and the ground electrode 206. The thin film optical waveguide 207 having the convex shape includes side wall surfaces 207A and a flat surface 207B. Furthermore, a step portion 204A that covers the entirety of the thin film optical waveguide 207 having the convex shape is also present on the buffer layer 204 at a positioned between the signal electrode 205 and the ground electrode 206.

With the thin film optical waveguide 207 having the configuration described above is able to modulate light propagating through the thin film optical waveguide 207 by generating an electric field by applying a voltage to the signal electrode 205 and by changing the refractive index of the thin film optical waveguide 207.

Patent Document 1: U.S. Patent No. 2013/0170781

Patent Document 2: Japanese Laid-open Patent Publication No. 2000-66157

The composition of a buffer layer 204 is determined to have an appropriate resistance value in order to suppress a DC drift that varies as a temporal change in emission light occurring caused by, for example, the applied DC voltage. However, if the buffer layer 204 is formed on the thin film optical waveguide 207, the thickness of the step portion 204A of the buffer layer 204 that covers the side wall surfaces 207A of the thin film optical waveguide 207 becomes thinner than the thickness of the step portion 204A of the buffer layer 204 that covers the flat surface 207B of the thin film optical waveguide 207. As a result, a crack occurs in the step portion 204A of the buffer layer 204 that covers the side wall surfaces 207A of the thin film optical waveguide 207, and thus, a resistance value of the buffer layer 204 tends to be changed in a rising direction. Therefore, for example, a DC drift that is not subjected to optical modulation even if a DC voltage is applied is changed to a positive direction and thus the DC drift becomes unstable, which may possible shorten the life of the optical modulator.

### SUMMARY

According to an aspect of an embodiment, an optical device includes an optical waveguide, a buffer layer, and an electrode. The optical waveguide is a projected section and is disposed at a predetermined portion on a thin film substrate. The buffer layer is formed on the thin film substrate and the optical waveguide. The electrode is formed on the buffer layer and applies a voltage to the optical waveguide. The electrode covers a step portion of the buffer layer formed on side walls of the optical waveguide.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to an embodiment;

FIG. 2 is a schematic plan view illustrating an example of a configuration of an optical modulator according to a first embodiment;

FIG. 3A is a schematic cross-sectional view illustrating an example of a first DC electrode included in the optical modulator according to the first embodiment;

FIG. 3B is a schematic cross-sectional view illustrating an example of a second DC electrode included in an optical modulator according to the first embodiment;

FIG. 4 is a schematic cross-sectional view illustrating an example of a RF electrode included in the optical modulator according to the first embodiment;

FIG. 5A is a diagram illustrating an example of a formation step of an intermediate layer included in the first DC electrode;

FIG. 5B is a diagram illustrating an example of a formation step of an LN substrate included in the first DC electrode;

FIG. 5C is a diagram illustrating an example of a polishing step of the first DC electrode;

FIG. 6A is a diagram illustrating an example of a formation step of a thin film optical waveguide included in the first DC electrode;

FIG. 6B is a diagram illustrating an example of a formation step of a buffer layer included in the first DC electrode;

FIG. 6C is a diagram illustrating an example of a formation step of an electrode of the first DC electrode;

FIG. 7A is a diagram illustrating an example of a relationship of a DC drift of the DC electrode in a comparative example;

FIG. 7B is a diagram illustrating an example of a relationship of a DC drift of the first DC electrode according to the first embodiment;

FIG. 8 is a diagram illustrating an example of a temporal change in a DC drift of the optical modulator;

FIG. 9A is a schematic cross-sectional view illustrating an example of a first DC electrode according to a second embodiment;

FIG. 9B is a schematic cross-sectional view illustrating an example of a RF electrode according to the second embodiment;

FIG. 10A is a schematic cross-sectional view illustrating an example of a first DC electrode according to a third embodiment;

FIG. 10B is a schematic cross-sectional view illustrating an example of a RF electrode according to the third embodiment;

FIG. 11A is a schematic cross-sectional view illustrating an example of a first DC electrode according to a fourth embodiment;

FIG. 11B is a schematic cross-sectional view illustrating an example of a RF electrode according to the fourth embodiment;

FIG. 12A is a schematic cross-sectional view illustrating an example of a first DC electrode according to a fifth embodiment;

FIG. 12B is a schematic cross-sectional view illustrating an example of a RF electrode according to the fifth embodiment;

FIG. 13 is a diagram illustrating an example of a coupling structure of an optical waveguide between a first DC electrode and a RF electrode of an optical modulator according to a sixth embodiment; and

FIG. 14 is a schematic cross-sectional view illustrating an example of a DC electrode of an optical modulator.

### DESCRIPTION OF EMBODIMENTS

Preferred embodiments of the present invention will be explained with reference to accompanying drawings. Furthermore, the present invention is not limited to the embodiments.

### [a] First Embodiment

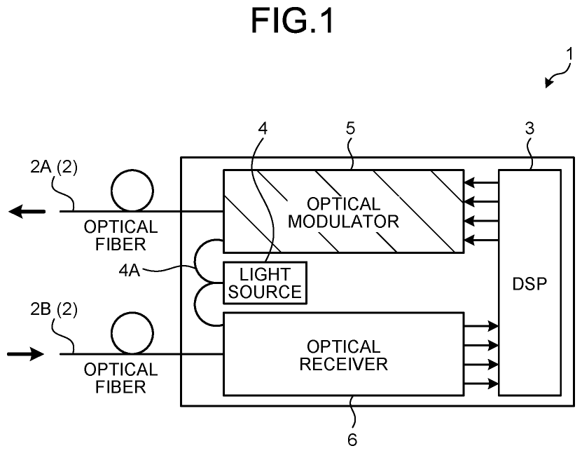

FIG. 1 is a block diagram illustrating an example of a configuration of an optical communication apparatus 1 according to an embodiment. The optical communication apparatus 1 illustrated in FIG. 1 is connected to an optical fiber 2A (2) disposed on the output side and an optical fiber 2B (2) disposed on the input side. The optical communication apparatus 1 has a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6 and obtains reception data by performing a process of decoding the acquired electrical signal.

The light source 4 includes, for example, a laser diode or the like, generates light with a predetermined wavelength, and supplies the generated light to the optical modulator 5 and the optical receiver 6. The optical modulator 5 is an optical device that modulates, by using an electrical signal that is output from the DSP 3, the light supplied from the light source 4 and that outputs the obtained optical transmission signal to the optical fiber 2A. The optical modulator 5 is an optical device, such as an LN optical modulator, that includes, for example, a lithium niobate (LN) optical waveguide and a signal electrode having a coplanar waveguide (CPW) structure. The LN optical waveguide is formed of a LN crystal substrate. The optical modulator 5 generates an optical transmission signal by modulating, when light supplied from the light source 4 propagates through the LN optical waveguide, the light by the electrical signal that is input to the signal electrode.

The optical receiver 6 receives an optical signal from the optical fiber 2B and demodulates the received optical signal by using the light supplied from the light source 4. Then, the optical receiver 6 converts the demodulated received optical signal to an electrical signal, and then, outputs the converted electrical signal to the DSP 3.

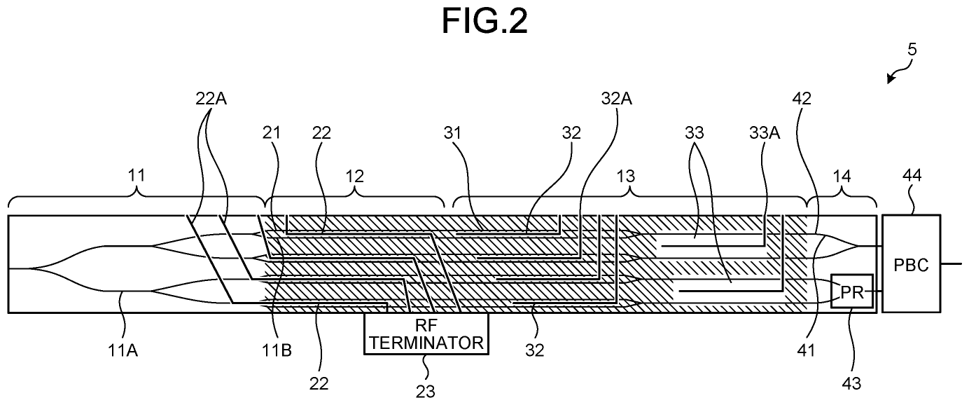

FIG. 2 is a schematic plan view illustrating an example of a configuration of the optical modulator 5 according to the first embodiment. The optical modulator 5 illustrated in FIG. 2 has a configuration in which an optical fiber 4A from the light source 4 is connected to the input side and the optical fiber 2A that is used to output a transmission signal is connected to the output side. The optical modulator 5 includes a first optical input unit 11, a radio frequency (RF) modulating unit 12 that is a second optical adjustment unit, a direct current (DC) applying unit 13 that is a first optical adjustment unit, and a first optical output unit 14. The first optical input unit 11 includes a first optical waveguide 11A and a first waveguide joining portion 11B. The first optical waveguide 11A includes a single optical waveguide connected to the optical fiber 4A, two optical waveguides that are branched off from the single optical waveguide, four optical waveguides that are branched off from the associated two optical waveguides, and eight optical waveguides that are branched off from the associated four optical waveguides. The first waveguide joining portion 11B joins a portion between the eight optical waveguides included in the first optical waveguide 11A and the respective eight LN optical waveguides included in the LN optical waveguide 21.

The RF modulating unit 12 includes the LN optical waveguide 21, a RF electrode 22, and a RF terminator 23. When the light supplied from the first optical waveguide 11 propagates through the LN optical waveguide 21, the RF modulating unit 12 modulates the light by using an electric field applied by a signal electrode 22A included in the RF electrode 22. The LN optical waveguide 21 is an optical waveguide formed by using, for example, a thin film LN substrate 53, and has eight parallel LN optical waveguides obtained by repeatedly branching off from the input side. The light that is modulated while propagating through the LN optical waveguide 21 is output to a first DC electrode 32 included in the DC applying unit 13. The thin film LN substrate 53 is an X-cut substrate in which the refractive index is increased when a DC voltage is applied in the direction of an X-axis of the crystal.

The signal electrode 22A included in the RF electrode 22 is a transmission path having a CWP structure and that is disposed at a position that do not overlap with the position of the LN optical waveguide 21 and applies an electric field to the LN optical waveguide 21 in accordance with the electrical signal that is output from the DSP 3. The termination of the signal electrode 22A included in the RF electrode 22 is connected to the RF terminator 23. The RF terminator 23 is connected to the termination of the signal electrode 22A and prevents unneeded reflection of a signal transmitted by the signal electrode 22A.

The DC applying unit 13 includes an LN optical waveguide 31 joined to the LN optical waveguide 21 included in the RF modulating unit 12, the first DC electrodes 32, and second DC electrodes 33. The first DC electrodes 32 are four child-side Mach-Zehnder (MZ) portions. The second DC electrodes 33 are two parent-side MZ portions.

The LN optical waveguide 31 includes eight LN optical waveguides, and four LN optical waveguides that merge with the two LN optical waveguides out of the eight LN optical waveguide. The eight LN optical waveguides 31 are provided with the first DC electrodes 32 at intervals of two LN optical waveguides. By applying a bias voltage to a signal electrode 32A on the LN optical waveguide 31, each of the first DC electrodes 32 adjusts the bias voltage such that ON/OFF of the electrical signal is associated with ON/OFF of the optical signal, and then, outputs an I signal having an in-phase component or a Q signal having a quadrature component. The four LN optical waveguides included in the LN optical waveguide 31 are provided with the second DC electrodes 33 at intervals of two LN optical waveguides. By applying a bias voltage to a signal electrode 33A on the LN optical waveguide 31, each of the second DC electrodes 33 adjusts the bias voltage such that ON/OFF of the electrical signal is associated with ON/OFF of the optical signal, and then, outputs the I signal or the Q signal.

The first optical output unit 14 includes a second waveguide joining portion 41, a second optical waveguide 42, a polarization rotator (PR) 43, and a polarization beam combiner (PBC) 44. The second waveguide joining portion 41 joins a portion between the LN optical waveguide 31 included in the DC applying unit 13 and the second optical waveguide 42. The second optical waveguide 42 includes four optical waveguides connected to the second waveguide joining portion 41 and also includes two optical waveguides that merge with the two optical waveguides out of the four optical waveguides.

The PR 43 rotates the I signal or the Q signal that is input from one of the second DC electrodes 33 by 90 degrees and obtains a vertical polarization optical signal that is rotated by 90 degrees. Then, the PR 43 inputs the vertical polarization optical signal to the PBC 44. The PBC 44 multiplexes the vertical polarization optical signal that is input from the PR 43 and a horizontal polarization optical signal that is input from the other of the second DC electrodes 33, and then, outputs a polarization division multiplexing signal.

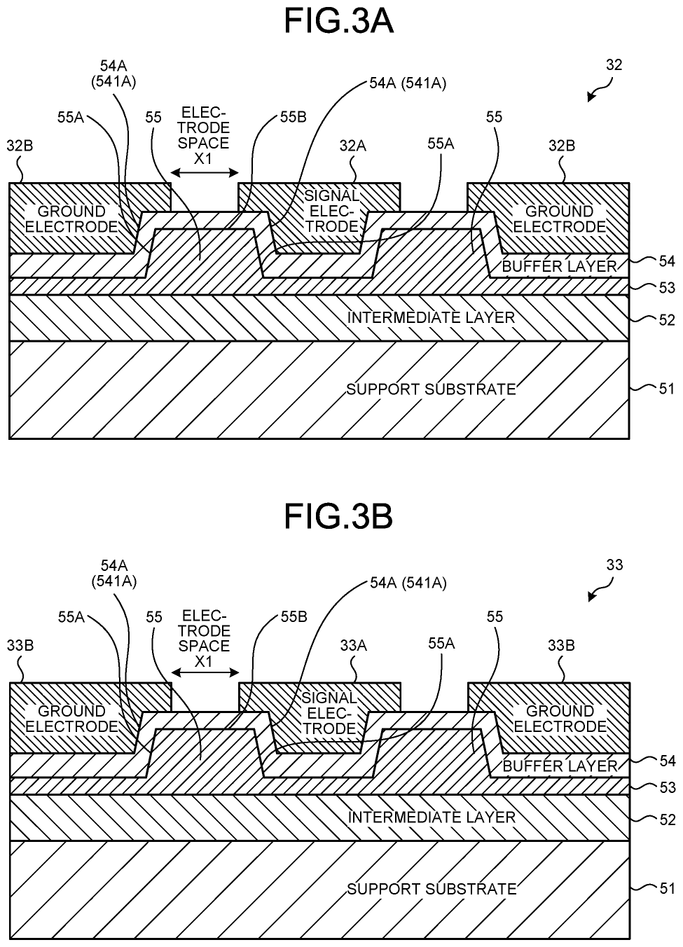

In the following, a configuration of the optical modulator 5 according to the first embodiment will be specifically described. FIG. 3A is a schematic cross-sectional view illustrating an example of the first DC electrode 32 included in the optical modulator 5 according to the first embodiment. The first DC electrode 32 illustrated in FIG. 3A includes a support substrate 51, and an intermediate layer 52 that is formed (or laminated) on the support substrate 51. Furthermore, the first DC electrode 32 includes the thin film LN substrate 53 that is formed (or laminated) on the intermediate layer 52, a buffer layer 54 that is formed (or laminated) on the thin film LN substrate 53, and the signal electrode 32A and ground electrodes 32B that have a CWP structure and that are formed (or laminated) on the buffer layer 54.

On the thin film LN substrate 53, thin film optical waveguides 55 each of which is formed of a substrate using a LN-crystal thin film and has a convex shape protruding upward at a predetermined portion are formed. Then, the thin film LN substrate 53 and the thin film optical waveguides 55 are covered by the buffer layer 54, the signal electrode 32A and a pair of the ground electrodes 32B having a CWP structure are disposed on the surface of the buffer layer 54. In other words, on the buffer layer 54, the signal electrode 32A and the pair of the ground electrodes 32B that sandwich the signal electrode 32A are disposed.

The thin film optical waveguides 55 each having a projection, for example, a convex shape are formed on the thin film LN substrate 53 at a position between the signal electrode 32A and ground electrode 32B. Each of the thin film optical waveguides 55 having the convex shape includes side wall surfaces 55A and a flat surface 55B. Furthermore, step portions 54A each of which covers the entirety of the thin film optical waveguides 55 and has a convex shape are also formed on the buffer layer 54 at a position between the signal electrode 32A and the ground electrode 32B. The step portion 54A that covers the side wall surfaces 55A of the thin film optical waveguide 55 covers side wall surfaces 541A by a part of the ground electrode 32B and the signal electrode 32A.

The support substrate 51 is a substrate made of silicon (Si) or the like. The intermediate layer 52 is a layer formed of, for example, a transparent member having a high refractive index, such as SiO₂ or TiO₂. Similarly, the buffer layer 54 is a layer made of SiO₂, TiO₂, or the like.

The thin film LN substrate 53 with a thickness of 0.5 to 3 μm is sandwiched between the intermediate layer 52 and the buffer layer 54, and the thin film optical waveguides 55 each of which protrudes upward and has a convex shape are formed on the thin film LN substrate 53. The width of the protrusion corresponding to each of the thin film optical waveguides 55 is about, for example, 1 to 8 μm. The thin film LN substrate 53 and the thin film optical waveguides 55 are covered by the buffer layer 54, and the signal electrode 32A and the ground electrodes 32B are disposed on the surface of the buffer layer 54. Namely, the signal electrode 32A faces the pair of the ground electrodes 32B. An electrode space between the signal electrode 32A and the ground electrode 32B is denoted by X1.

The signal electrode 32A is formed of, for example, a metal material made of gold, copper, or the like, and is a signal electrode with a width of 2 to 10 μm and a thickness of 1 to 20 μm. Each of the ground electrodes 32B is formed of, for example, a metal material made of aluminum or the like, and is a ground electrode with a thickness of 1 μm or more. A high-frequency signal in accordance with the electrical signal that is output from the DSP 3 is transmitted by the signal electrode 32A, so that an electric field in a direction from the signal electrode 32A toward each of the ground electrodes 32B is generated, and the generated electric field is applied to the thin film optical waveguide 55. As a result, the refractive index of each of the thin film optical waveguides 55 is changed in accordance with the electric field applied to each of the thin film optical waveguides 55 and it is thus possible to modulate the light that propagates through each of the thin film optical waveguides 55.

FIG. 3B is a schematic cross-sectional view illustrating an example of the second DC electrode 33 included in the optical modulator 5 according to the first embodiment. The second DC electrode 33 illustrated in FIG. 3B includes the support substrate 51 and the intermediate layer 52 that is formed on the support substrate 51. Furthermore, the second DC electrode 33 includes the thin film LN substrate 53 that is formed on the intermediate layer 52, the buffer layer 54 that is formed on the thin film LN substrate 53, and the signal electrode 33A and ground electrodes 33B that have a CWP structure and that are formed on the buffer layer 54.

The thin film optical waveguides 55 each of which has a convex shape and protrudes upward and are formed on the thin film LN substrate 53. Then, the thin film LN substrate 53 and the thin film optical waveguides 55 are covered by the buffer layer 54, and the signal electrode 33A and a pair of the ground electrodes 33B having a CWP structure are disposed on the surface of the buffer layer 54. Namely, the signal electrode 33A and the pair of the ground electrodes 33B located between the signal electrode 33A are disposed on the buffer layer 54. An electrode space between the signal electrode 33A and the ground electrode 33B is denoted by X1.

Each of the thin film optical waveguides 55 having a convex shape is formed on the thin film LN substrate 53 at a position between the signal electrode 33A and the ground electrode 33B. Each of the thin film optical waveguides 55 having a convex shape includes the side wall surfaces 55A and the flat surface 55B. Furthermore, the step portions 54A each of which covers the entirety of the thin film optical waveguide 55 and has a convex shape are also formed on the buffer layer 54 at a position between the signal electrode 33A and the ground electrode 33B. The step portion 54A that covers the side wall surfaces 55A of the thin film optical waveguide 55 covers the side wall surfaces 541A of the step portion 54A by a part of the ground electrode 33B and the signal electrode 33A.

The signal electrode 33A is formed of, for example, a metal material made of gold, copper, or the like, and is a signal electrode with a width of 2 to 10 μm and a thickness of 1 to 20 μm. Each of the ground electrodes 33B is formed of, for example, metal material made of gold, copper, aluminum or the like, and is a ground electrode with a thickness of 1 μm or more. A high-frequency signal in accordance with the electrical signal that is output from the DSP 3 is transmitted by the signal electrode 33A, so that an electric field in a direction from the signal electrode 33A toward each of the ground electrodes 33B is generated, and the generated electric field is applied to the thin film optical waveguide 55. As a result, the refractive index of each of the thin film optical waveguides 55 is changed in accordance with the electric field applied to each of the thin film optical waveguides 55 and it is thus possible to modulate the light that propagates through each of the thin film optical waveguides 55.

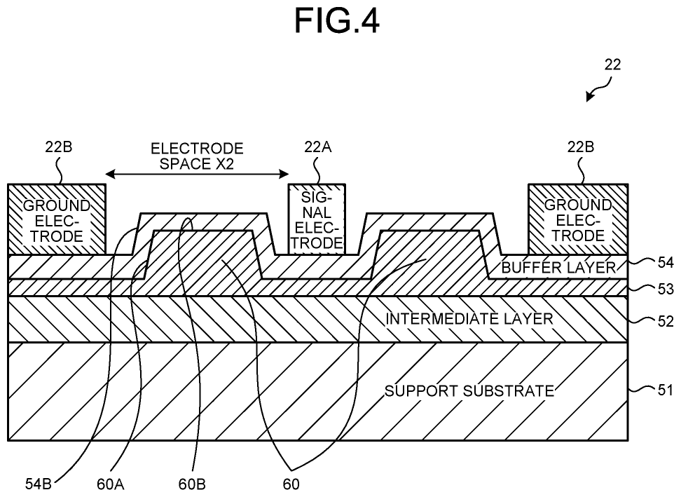

FIG. 4 is a schematic cross-sectional view illustrating an example of the RF electrode 22 included in the optical modulator 5 according to the first embodiment. The RF electrode 22 illustrated in FIG. 4 includes the support substrate 51 and the intermediate layer 52 that is formed on the support substrate 51. Furthermore, the RF electrode 22 includes the thin film LN substrate 53 that is formed on the intermediate layer 52, the buffer layer 54 that is formed on the thin film LN substrate 53, and the signal electrode 22A and ground electrodes 22B that have a CWP structure and that are formed on the buffer layer 54.

Thin film optical waveguides 60 each of which has a convex shape and protrudes upward are formed on the thin film LN substrate 53. Then, the thin film LN substrate 53 and the thin film optical waveguides 60 are covered by the buffer layer 54, and the signal electrode 22A and a pair of the ground electrodes 22B having a CWP structure are disposed on the surface of the buffer layer 54. Namely, the signal electrode 22A and the pair of the ground electrodes 22B located between the signal electrode 22A are disposed on the buffer layer 54.

Each of the thin film optical waveguides 60 having a convex shape is formed on the thin film LN substrate 53 at a position between the signal electrode 22A and the ground electrode 22B. Each of the thin film optical waveguides 60 having a convex shape includes side wall surfaces 60A and a flat surface 60B. Furthermore, step portions 54B each of which covers the entirety of the thin film optical waveguide 60 and has a convex shape are also formed on the buffer layer 54 at a position between the signal electrode 22A and the ground electrode 22B. Side wall surfaces 541B of the step portion 54B that cover the side wall surfaces 60A of the thin film optical waveguide 60 are separated from the ground electrodes 22B and the signal electrode 22A.

The thin film LN substrate 53 with the thickness of 0.5 to 3 μm is sandwiched between the intermediate layer 52 and the buffer layer 54, and the thin film optical waveguides 60 each of which have a convex shape and protrudes upward are formed on the thin film LN substrate 53. The width of the protrusion corresponding to the thin film optical waveguide 60 is about, for example, 1 to 8 μm. The thin film LN substrate 53 and the thin film optical waveguides 60 are covered by the buffer layer 54, and the signal electrode 22A and the ground electrodes 22B are disposed on the surface of the buffer layer 54. An electrode space between the signal electrode 22A and the ground electrode 22B is denoted by X2. Furthermore, it is assumed to be electrode space X1<electrode space X2.

Furthermore, it is preferable that the signal electrode 22A be formed of a material in which a high frequency loss is small and a material that is different from that of the ground electrode 22B.

The signal electrode 22A is formed of, for example, a metal material made of gold, copper, or the like, and is an electrode with a width of 2 to 10 μm and a thickness of 1 to 20 μm. Each of the ground electrodes 22B is formed of, for example, a metal material made of aluminum or the like, and is an electrode with a thickness of 1 μm or more. A high-frequency signal in accordance with the electrical signal that is output from the DSP 3 is transmitted from the signal electrode 22A, so that an electric field in a direction from the signal electrode 22A toward each of the ground electrodes 22B is generated, and the generated electric field is applied to the thin film optical waveguide 60. As a result, the refractive index of the thin film optical waveguide 60 is changed in accordance with the electric field applied to the thin film optical waveguide 60 and it is thus possible to modulate the light that propagates through each of the thin film optical waveguides 60.

In the following, a diagram illustrating an example of manufacturing steps of the first DC electrode 32 according to the first embodiment will be described. Furthermore, a description will be made of the manufacturing steps of the first DC electrode 32; however, the same steps are included in the manufacturing steps of the second DC electrode 33. Therefore, by assigning the same reference numerals to steps having the same steps, overlapped descriptions of the configurations and the steps thereof will be omitted.

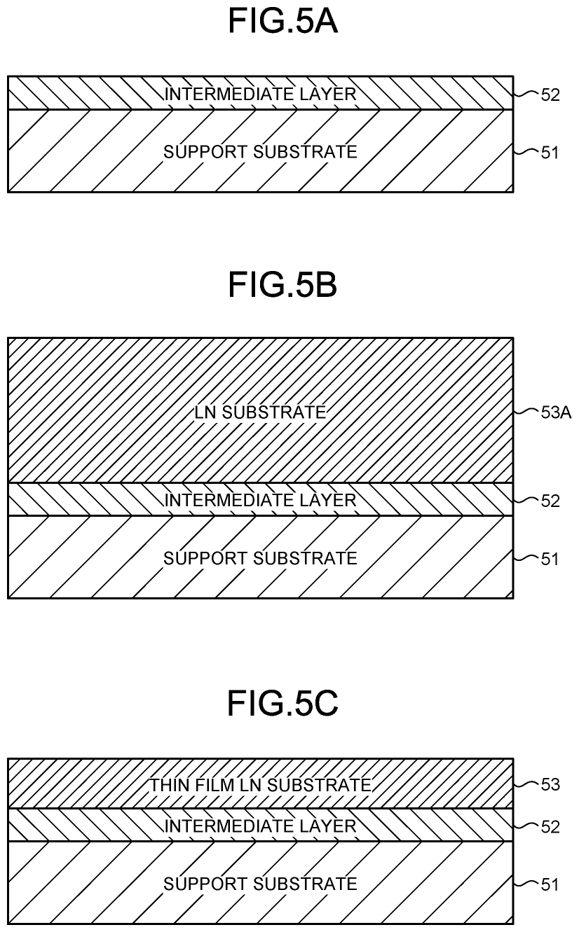

FIG. 5A is a diagram illustrating a formation step of an intermediate layer included in the first DC electrode 32. The intermediate layer 52 is formed on the support substrate 51 illustrated in FIG. 5A. FIG. 5B is a diagram illustrating an example of a formation step of an LN substrate included in the first DC electrode 32. A LN substrate 53A is bonded onto the intermediate layer 52 illustrated in FIG. 5B. FIG. 5C is a diagram illustrating an example of a polishing step of the first DC electrode 32. The LN substrate 53A bonded onto the intermediate layer 52 illustrated in FIG. 5C is formed to a thin film by performing a polishing process or the like thereon, so that the thin film LN substrate 53 is formed on the intermediate layer 52.

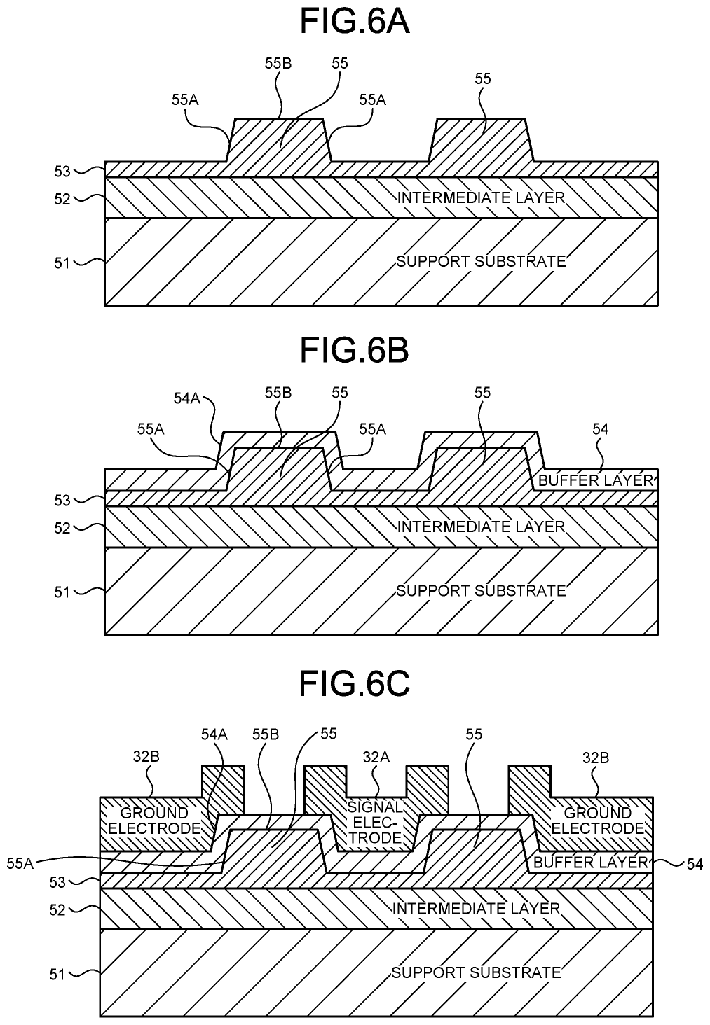

FIG. 6A is a diagram illustrating an example of a formation step of a thin film optical waveguide of the first DC electrode 32. The thin film optical waveguide 55 having a convex shape is formed at a predetermined portion on the thin film LN substrate 53 by etching the thin film LN substrate 53 illustrated in FIG. 6A.

FIG. 6B is a diagram illustrating an example of a formation step of a buffer layer included in the first DC electrode 32. The buffer layer 54 is formed, as a film, on the thin film LN substrate 53 and the thin film optical waveguide 55 illustrated in FIG. 6B. The step portion 54A of the buffer layer 54 is formed on the thin film optical waveguide 55. At this time, the side walls of the step portion 54A may sometimes be thinner than the flat surface in a film formation process.

FIG. 6C is a diagram illustrating an example of a formation step of an electrode of the first DC electrode 32. After resist processing has been performed on the step portions 54A disposed on the flat surface 55B of the thin film optical waveguide 55 of the buffer layer 54 illustrated in FIG. 6C, the signal electrode 32A and a pair of the ground electrodes 32B are formed on the buffer layer 54 by performing an electrolytic plating process or the like. As a result, the thickness of the ground electrode 32B and the signal electrode 32A that are present on the step portion 54A on the side wall surface 55A of the thin film optical waveguide 55 is increased, so that the first DC electrode 32 is manufactured by removing an excess plating portion that is used to adjust the thickness of the ground electrode 32B and the signal electrode 32A.

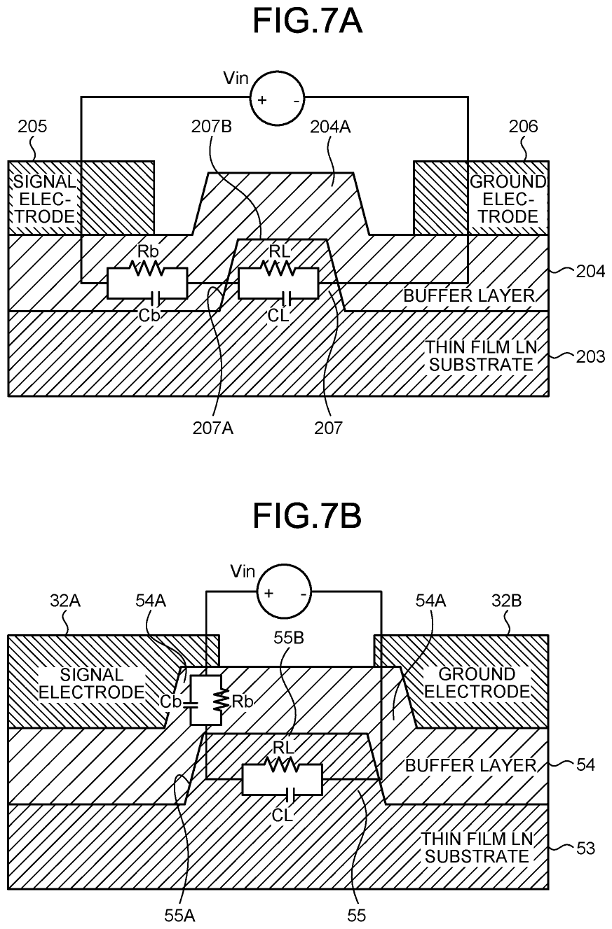

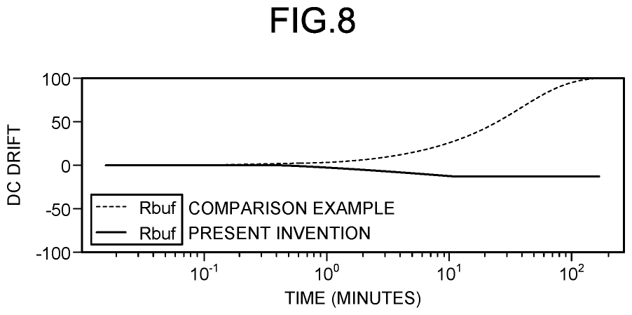

FIG. 7A is a diagram illustrating an example of a relationship of a DC drift of a DC electrode of an optical modulator in a comparative example, FIG. 7B is a diagram illustrating an example of a relationship of a DC drift of the first DC electrode 32 included in the optical modulator 5 according to the first embodiment, and FIG. 8 is a diagram illustrating an example of a temporal change of the DC drift of the optical modulator. The DC drift depends on resistance and capacitance of the buffer layer 204 (54) and the thin film optical waveguide 207 (55). The resistance of the buffer layer 204 (54) is denoted by Rb, the capacitance of the buffer layer 204 (54) is denoted by Cb, the resistance of the thin film optical waveguide 207 (55) is denoted by RL, and the capacitance of the thin film optical waveguide 207 (55) is denoted by CL.

The capacitance determines the electric field applied to the thin film optical waveguide 207 by the effect of accumulation of electric charges in the capacitance in an initial stage of the application of the electric field. Therefore, a voltage applied to the thin film optical waveguide 207 at the time at which a voltage Vin is applied between the signal electrode 205 and the ground electrode 206 is 1/(1+CL/Cb)*Vin. In contrast, when a predetermined period of time has elapsed, if the electric charges are accumulated in the capacitance and become stable, the resistance determines an electric field to be applied to the thin film optical waveguide 207. Therefore, the voltage applied to the thin film optical waveguide 207 at the time at which the voltage Vin is applied between the signal electrode 205 and the ground electrode 206 is RL/(Rb+RL)*Vin. Similarly, in an initial stage of the application of the electric field, the voltage applied to the thin film optical waveguide 55 at the time at which the voltage Vin is applied between the signal electrode 32A and the ground electrode 32B is also 1/(1+CL/Cb)*Vin. In contrast, when a certain period of time has elapsed, the voltage applied to the thin film optical waveguide 55 at the time at which the voltage Vin is applied between the signal electrode 32A and the ground electrode 32B is RL/(Rb+RL)*Vin.

Regarding the step portion 204A of the buffer layer 204 that covers the thin film optical waveguide 207 illustrated in FIG. 7A, the thickness of the step portion 204A of the buffer layer 204 is reduced, and thus, a crack occurs. Consequently, a resistance value of the buffer layer 204 is increased and thus become unstable caused by the surrounding environment. In particular, a crack tends to occur due to remarkable thinness of the side wall portions included in the step portion 204A.

At the DC electrode illustrated in FIG. 7A, if the resistance value Rb of the buffer layer 204 is higher than the resistance value RL of the thin film optical waveguide 207, the voltage applied to the thin film optical waveguide 207 at the time at which the voltage Vin is applied between the signal electrode 205 and the ground electrode 206 is decreased, and light is less likely to be modulated. Furthermore, the voltage applied to the thin film optical waveguide 207 is RL/(Rb+RL)*Vin. As a result, as illustrated in FIG. 8, the DC drift is changed in a positive direction (light is not modulated even when a DC voltage is applied). In particular, the influence thereof is remarkable because an X-cut substrate is applied to the thin film optical waveguide 207.

In contrast, at the first DC electrode 32 illustrated in FIG. 7B, the side wall portions included in the step portion 54A of the buffer layer 54 are covered by a part of the signal electrode 32A and the ground electrode 32B, so that the resistance value Rb of the buffer layer 54 becomes stable and small. Furthermore, because the voltage (RL/(Rb+RL)*Vin) applied to the thin film optical waveguide 55 becomes stable and high, as illustrated in FIG. 8, it is possible to prevent the DC drift from being changed in the positive direction. In addition, even when the thickness of the side walls of the step portion 54A of the buffer layer 54 that covers the thin film optical waveguide 55 is decreased, the subject side walls are covered by a portion of the signal electrode 32A and the ground electrode 32B; therefore, it is possible to increase the strength of the side walls of the step portion 54A and avoid a situation in which a crack described above in the comparative example occurs. As a result, it is possible to avoid a situation in which the resistance value of the buffer layer 54 is increased due to a crack, and it is thus possible to stabilize the resistance value. In particular, the effect thereof is remarkable because an X-cut substrate is applied to the thin film optical waveguide 55.

the first DC electrode 32 included in the optical modulator 5 according to the first embodiment covers the step portion 54A of the buffer layer 54 that is formed on the side wall surfaces 55A of the thin film optical waveguide 55 having a convex shape by a part of the signal electrode 32A and the ground electrode 32B. As a result, the resistance value of the step portion 54A becomes stable and small due to the cover by the signal electrode 32A and the ground electrode 32B. The voltage applied to the thin film optical waveguide 55 becomes stable and high, so that it is possible to prolong the life of the optical modulator 5 by avoiding a situation in which the DC drift is changed in the positive direction.

The second DC electrode 33 covers the step portion 54A of the buffer layer 54 formed on the side wall surfaces 55A of the thin film optical waveguide 55 having the convex shape by a part of the signal electrode 33A and the ground electrode 33B. As a result, the resistance value of the step portion 54A becomes stable and small due to the cover by the signal electrode 33A and the ground electrode 33B. The voltage applied to the thin film optical waveguide 55 becomes stable and high, so that it is possible to prolong the life of the optical modulator 5 by avoiding a situation in which the DC drift is changed in the positive direction.

The electrode space X1 between the signal electrode 32A and the ground electrode 32B included in the first DC electrode 32 is made narrower than the electrode space X2 between the signal electrode 22A and the ground electrode 22B included in the RF electrode 22, so that it is possible to cover the step portion 54A by a part of the signal electrode 32A and the ground electrode 32B.

In contrast, the electrode space X2 between the signal electrode 22A and the ground electrode 22B included in the RF electrode 22 in the optical modulator 5 is made wider than the electrode space X1 between the signal electrode 32A and the ground electrode 32B included in the first DC electrode 32; therefore, it is possible to increase the width of the modulation bandwidth by reducing a propagation loss of the high-frequency signal.

The electrode space X1 between the ground electrode 33B and the signal electrode 33A included in the second DC electrode 33 is made narrower than the electrode space X2 between the ground electrode 22B and the signal electrode 22A included in the RF electrode 22; therefore, it is possible to cover the step portion 54A by a part of the signal electrode 33A and the ground electrode 33B.

Furthermore, for convenience of description, the LN optical modulator has been exemplified as the optical modulator 5; however, for example, a polymer modulator may also be used, and appropriate modifications are possible.

Furthermore, regarding the optical modulator 5 according to the first embodiment, a case has been described as one example in which an electrode space between the first DC electrode 32 and the RF electrode 22 is adjusted; however, a waveguide width of the first DC electrode 32 and the RF electrode 22 may also be adjusted and an embodiment thereof will be described as a second embodiment.

### [b] Second Embodiment

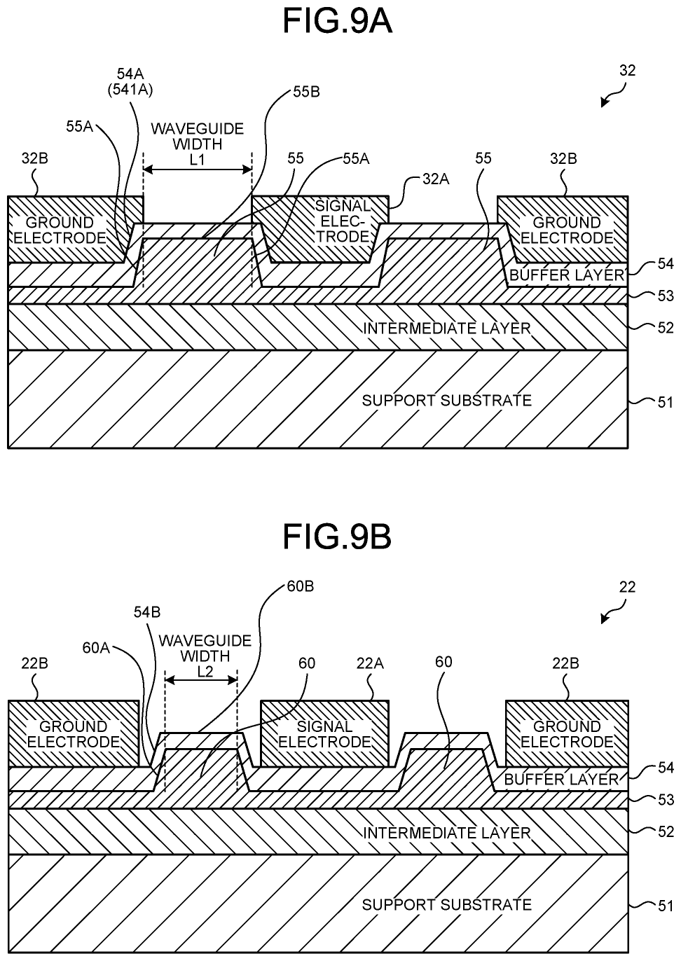

FIG. 9A is a schematic cross-sectional view illustrating an example of the first DC electrode 32 according to the second embodiment, and FIG. 9B is a schematic cross-sectional view illustrating an example of the RF electrode 22 according to the second embodiment. Furthermore, by assigning the same reference numerals to components having the same configuration as those in the optical modulator 5 according to the first embodiment, overlapping descriptions of the configuration and the operation thereof will be omitted. The waveguide width L1 that is the width of the flat surface 55B of the thin film optical waveguide 55 included in the first DC electrode 32 illustrated in FIG. 9A is made to narrower than the waveguide width L2 that is the width of the flat surface 60B of the thin film optical waveguide 60 included in the RF electrode 22 illustrated in FIG. 9B.

As a result, the waveguide width L2 of the RF electrode 22 is made wider than the waveguide width L1 of the first DC electrode 32; therefore, a probability that short circuits occur between the ground electrode 22B and the signal electrode 22A caused by an error in a manufacturing process is reduced and it is thus possible to suppress a reduction in yields.

Furthermore, also regarding the first DC electrode 32 included in the optical modulator 5, the step portion 54A of the buffer layer 54 formed on the side wall surfaces 55A of the thin film optical waveguide 55 having the convex shape is covered by a part of the signal electrode 32A and the ground electrode 32B. As a result, the resistance value of the step portion 54A becomes stable and small, and, furthermore, the voltage applied to the thin film optical waveguide 55 becomes stable and high, so that it is possible to prolong the life of the optical modulator 5 by avoiding a situation in which the DC drift is changed in the positive direction.

However, if the waveguide width L1 of the flat surface 55B of the thin film optical waveguide 55 included in the first DC electrode 32 according to the second embodiment is excessively increased, the space between the thin film optical waveguides 55 is decreased, resulting in a problem of optical coupling between the thin film optical waveguides 55. Therefore, an embodiment of the optical modulator 5 for solving the problem of this optical coupling will be described as a third embodiment.

### [c] Third Embodiment

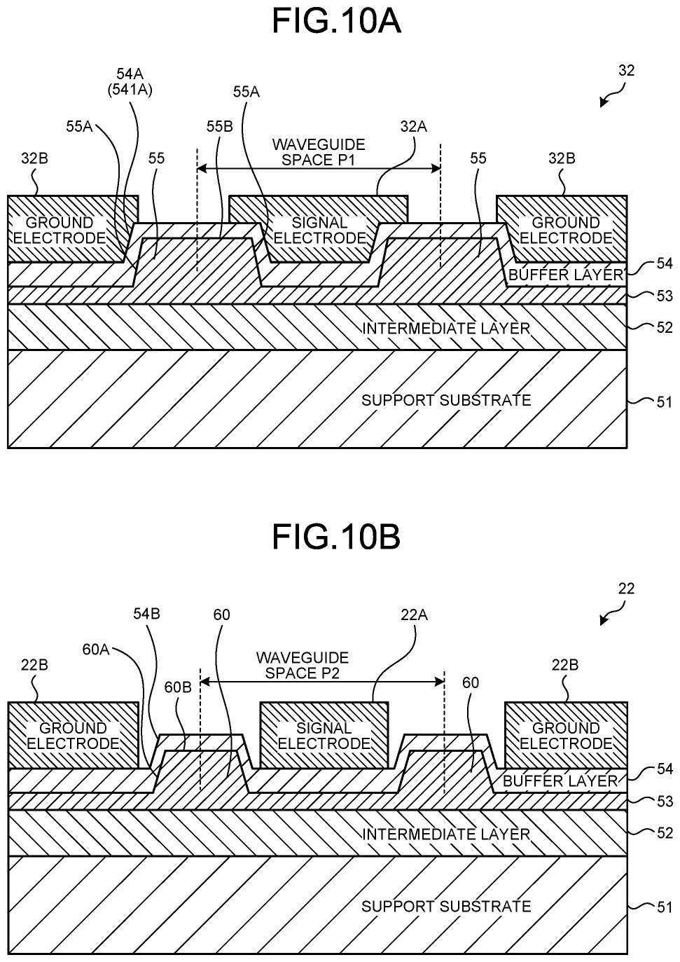

FIG. 10A is a schematic cross-sectional view illustrating an example of the first DC electrode 32 according to the third embodiment, and FIG. 10B is a schematic cross-sectional view illustrating an example of the RF electrode 22 according to the third embodiment. Furthermore, by assigning the same reference numerals to components having the same configuration as those in the optical modulator 5 according to the first embodiment, overlapping descriptions of the configuration and the operation thereof will be omitted. A waveguide space P1 between the thin film optical waveguides 55 that are adjacent with each other and that sandwiches the signal electrode 32A included in the first DC electrode 32 illustrated in FIG. 10A is made wider than the waveguide space P2 between the thin film optical waveguides 60 that are adjacent with each other and that sandwiches the signal electrode 22A included in the RF electrode 22 illustrated in FIG. 10B. As a result, it is possible to solve the problem of the optical coupling between the waveguides.

Furthermore, also regarding the first DC electrode 32 included in the optical modulator 5, the step portion 54A of the buffer layer 54 formed on the side wall surfaces 55A of the thin film optical waveguide 55 having the convex shape is covered by a part of the signal electrode 32A and the ground electrode 32B. As a result, the resistance value of the step portion 54A becomes stable and small, and, furthermore, the voltage applied to the thin film optical waveguide 55 becomes stable and high, so that it is possible to prolong the life of the optical modulator 5 by avoiding a situation in which the DC drift is changed in the positive direction.

Furthermore, with the optical modulator 5 according to the first embodiment, if the electrode space between the signal electrode 32A and the ground electrode 32B included in the first DC electrode 32 is made narrow, a probability that short circuits occur between the signal electrode 32A and the ground electrode 32B caused by an error in a manufacturing process is high. Thus, this situation can be avoided by reducing the thickness of the electrode. However, if the thickness of the RF electrode 22 is reduced, resistance is increased in a high frequency, resulting in degradation of the band. Therefore, a fourth embodiment will be described as an embodiment for solving this situation.

### [d] Fourth Embodiment

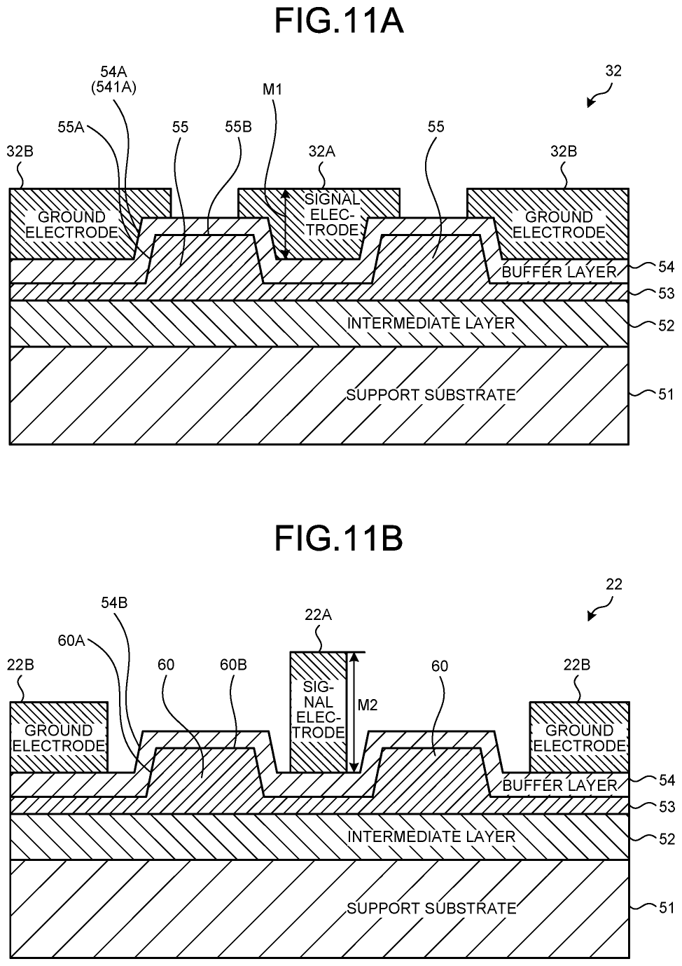

FIG. 11A is a schematic cross-sectional view illustrating an example of the first DC electrode 32 according to the fourth embodiment. FIG. 11B is a schematic cross-sectional view illustrating an example of the RF electrode 22 according to the fourth embodiment. Furthermore, by assigning the same reference numerals to components having the same configuration as those in the optical modulator 5 according to the first embodiment, overlapping descriptions of the configuration and the operation thereof will be omitted. A thickness M1 of the signal electrode 32A included in the first DC electrode 32 illustrated in FIG. 11A is made thinner than a thickness M2 of the signal electrode 22A included in the RF electrode 22 illustrated in FIG. 11B. As a result, it is possible to suppress an increase in resistance of the RF electrode 22 at the high frequency and avoid degradation of the band.

Furthermore, also regarding the first DC electrode 32 included in the optical modulator 5, the step portion 54A of the buffer layer 54 formed on the side wall surfaces 55A of the thin film optical waveguide 55 having the convex shape is covered by a part of the signal electrode 32A and the ground electrode 32B. As a result, the resistance value of the step portion 54A becomes stable and small, and, furthermore, the voltage applied to the thin film optical waveguide 55 becomes stable and high, so that it is possible to prolong the life of the optical modulator 5 by avoiding a situation in which the DC drift is changed in the positive direction.

### [e] Fifth Embodiment

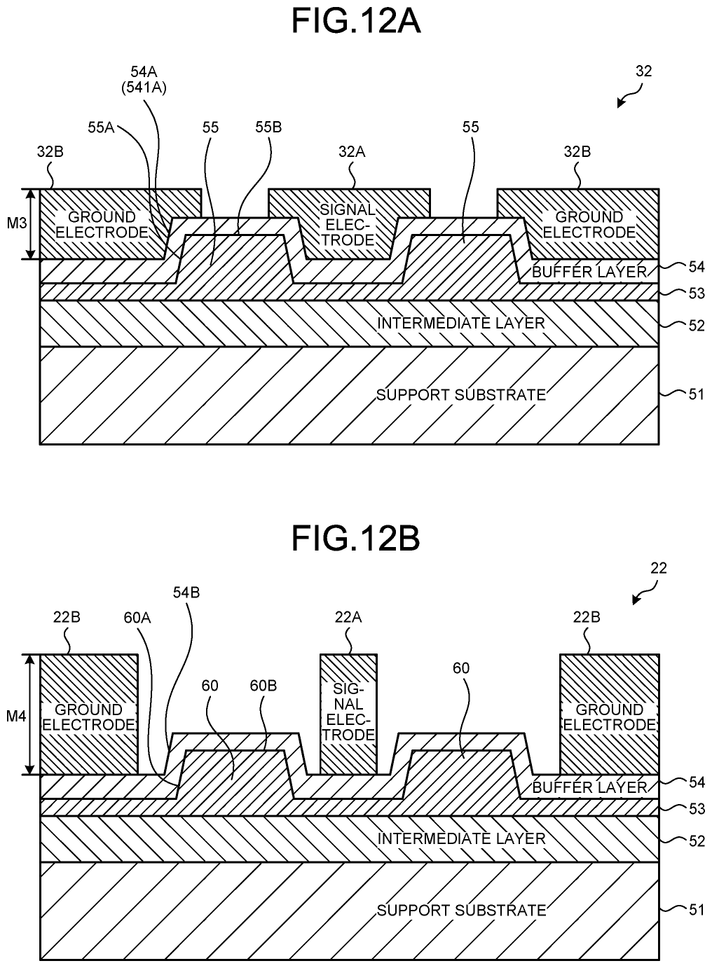

FIG. 12A is a schematic cross-sectional view illustrating an example of the first DC electrode according to the fifth embodiment, and FIG. 12B is a schematic cross-sectional view illustrating an example of the RF electrode according to the fifth embodiment. Furthermore, by assigning the same reference numerals to components having the same configuration as those in the optical modulator 5 according to the first embodiment, overlapping descriptions of the configuration and the operation thereof will be omitted. The thickness M3 of the ground electrode 32B included in the first DC electrode 32 illustrated in FIG. 12A is made thinner than the thickness M4 of the ground electrode 22B included in the RF electrode 22 illustrated in FIG. 12B. As a result, the thickness M3 of the ground electrode 32B included in the first DC electrode 32 is made thinner than the thickness M4 of the ground electrode 22B included in the RF electrode 22; therefore, it is possible to suppress a reduction in yields of the first DC electrode 32 while maintaining the band of the RF electrode 22.

Furthermore, also regarding the first DC electrode 32 of the optical modulator 5, the step portion 54A of the buffer layer 54 formed on the side wall surfaces 55A of the thin film optical waveguide 55 having the convex shape is covered by a portion of the signal electrode 32A and the ground electrode 32B. As a result, the resistance value of the step portion 54A becomes stable and small, and, furthermore, the voltage applied to the thin film optical waveguide 55 becomes stable and high, so that it is possible to prolong the life of the optical modulator 5 by avoiding a situation in which the DC drift is changed in the positive direction.

### [f] Sixth Embodiment

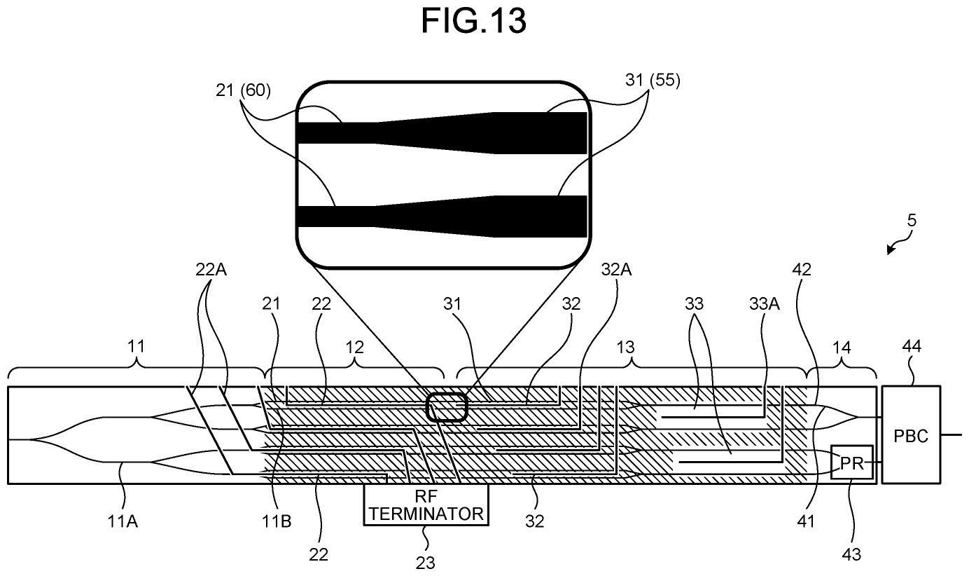

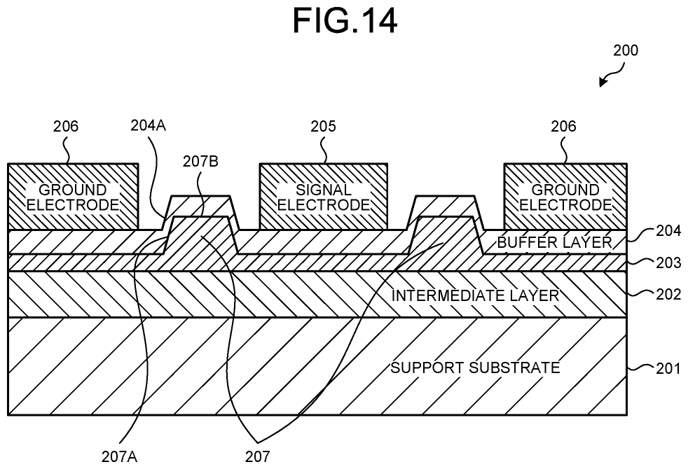

FIG. 13 is a diagram illustrating an example of the coupling structure of the optical waveguide between the first DC electrode 32 and the RF electrode 22 included in the optical modulator 5 according to the sixth embodiment. Furthermore, by assigning the same reference numerals to components having the same configuration as those in the optical modulator 5 according to the first embodiment, overlapping descriptions of the configuration and the operation thereof will be omitted. A joining portion between the thin film optical waveguide 60 included in the RF electrode 22 and the thin film optical waveguide 55 included in the first DC electrode 32 illustrated in FIG. 13 has a tapered structure such that the LN optical waveguide 21 (31) is gradually increased from the thin film optical waveguide 60 toward the thin film optical waveguide 55. As a result, even if the optical waveguide width of the thin film optical waveguide 60 included in the RF electrode 22 is different from the optical waveguide width of the thin film optical waveguide 55 included in the first DC electrode 32, it is possible to prevent an optical scattering loss from occurring between both of the thin film optical waveguides. It is possible to improve the efficiency of the optical propagation coupling from the thin film optical waveguide 60 of the RF electrode 22 to the thin film optical waveguide 55 of the first DC electrode 32.

According to an aspect of an embodiment of the optical device disclosed in the present invention, it is possible to suppress a change in a DC drift in the positive direction.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
an optical waveguide that is a projected section and that is disposed at a predetermined portion on a thin film substrate;
a buffer layer that is formed on the thin film substrate and the optical waveguide; and
an electrode that is formed on the buffer layer and that applies a voltage to the optical waveguide, wherein
the electrode covers a step portion of the buffer layer formed on side walls of the optical waveguide.

2. The optical device according to claim 1, further comprising:
a first optical adjustment unit for a DC electrode; and
a second optical adjustment unit for a RF electrode, wherein
the first optical adjustment unit includes
a first optical waveguide that is a projected section,
a first buffer layer that is formed on the thin film substrate and the first optical waveguide, and
a signal electrode and a ground electrode that are disposed on a direct current (DC) side, that are formed on the first buffer layer, and that apply a voltage to the first optical waveguide,
each of the signal electrode and the ground electrode disposed on the DC side covers the step portion of the first buffer layer formed on the side walls of the first optical waveguide,
the second optical adjustment unit includes
a second optical waveguide that is a projected section,
a second buffer layer that is formed on the thin film substrate and the second optical waveguide, and
a signal electrode and a ground electrode that are disposed on a radio frequency (RF) side, that are formed on the second buffer layer, and that apply a voltage to the second optical waveguide,
the signal electrode and the ground electrode disposed on the RF side are separated from the step portion of the second buffer layer formed on the side walls of the second optical waveguide, and
an electrode space between the signal electrode and the ground electrode on the DC side is made narrower than an electrode space between the signal electrode and the ground electrode disposed on the RF side.

3. The optical device according to claim 1, further comprising:
a first optical adjustment unit for a DC electrode; and
a second optical adjustment unit for a RF electrode, wherein
the first optical adjustment unit includes
a first optical waveguide,
a first buffer layer that is formed on the thin film substrate and the first optical waveguide, and
a signal electrode and a pair of ground electrode that are disposed on a DC side, that are formed on the first buffer layer, and that applies a voltage to the first optical waveguide,
each of the signal electrode and the ground electrodes disposed on the DC side covers the step portion of the first buffer layer formed on the side walls of the first optical waveguide,
the second optical adjustment unit includes
a second optical waveguide,
a second buffer layer that is formed on the thin film substrate and the second optical waveguide, and
a signal electrode and a pair of the ground electrodes that are disposed on a RF side, that are formed on the second buffer layer, and that apply a voltage to the second optical waveguide,
each of the signal electrode and the ground electrodes disposed on the RF side is separated from the step portion of the second buffer layer formed on the side walls of the second optical waveguide, and
a waveguide width of the first optical waveguide between the signal electrode and one of the ground electrodes disposed on the DC side is made longer than a waveguide width of the second optical waveguide between the signal electrode and the other of the ground electrodes disposed on the RF side.

4. The optical device according to claim 1, further comprising:
a first optical adjustment unit for a DC electrode; and
a second optical adjustment unit for a RF electrode, wherein
the first optical adjustment unit includes
a first optical waveguide that is a projected section,
a first buffer layer that is formed on the thin film substrate and the first optical waveguide, and
a signal electrode and a pair of ground electrodes that are disposed on a DC side, that are formed on the first buffer layer, and that apply a voltage to the first optical waveguide,
each of the signal electrode and the ground electrodes disposed on the DC side covers the step portion of the first buffer layer formed on the side walls of the first optical waveguide,
the second optical adjustment unit includes
a second optical waveguide that is a projected section,
a second buffer layer that is formed on the thin film substrate and the second optical waveguide, and
a signal electrode and a pair of ground electrodes that are disposed on a RF side, that are formed on the second buffer layer, and that apply a voltage to the second optical waveguide,
the signal electrode and the ground electrodes disposed on a RF side is separated from the step portion of the second buffer layer formed on the side walls of the second optical waveguide, and
a first waveguide space between the first optical waveguide between the signal electrode and one of the ground electrodes that are disposed on the DC side and the first optical waveguide between the signal electrode and the other of the ground electrodes that are disposed on the DC side is made longer than a second waveguide space between the second optical waveguide between the signal electrode and one of the ground electrodes that are disposed on the RF side and the second optical waveguide between the signal electrode and the other of the ground electrodes disposed on the RF side.

5. The optical device according to claim 1, further comprising:
a first optical adjustment unit for a DC electrode; and
a second optical adjustment unit for a RF electrode, wherein
the first optical adjustment unit includes
a first optical waveguide that is a projected section,
a first buffer layer that is formed on the thin film substrate and the first optical waveguide, and
a signal electrode and a pair of ground electrodes that are disposed on a DC side, that are formed on the first buffer layer, and that apply a voltage to the first optical waveguide,
each of the signal electrode and the ground electrodes disposed on the DC side covers the step portion of the first buffer layer formed on the side walls of the first optical waveguide,
the second optical adjustment unit includes
a second optical waveguide that is a projected section,
a second buffer layer that is formed on the thin film substrate and the second optical waveguide, and
a signal electrode and a pair of ground electrodes that are disposed on a RF side, that are formed on the second buffer layer, and that apply a voltage to the second optical waveguide,
the signal electrode and the ground electrodes disposed on the RF side are separated from the step portion of the second buffer layer formed on the side walls of the second optical waveguide, and
a first thickness of the signal electrode disposed on the DC side is made thinner than a second thickness of the signal electrode disposed on the RF side.

6. The optical device according to claim 1, further comprising
a first optical adjustment unit of a DC electrode; and
a second optical adjustment unit of a RF electrode, wherein
the first optical adjustment unit includes
a first optical waveguide that is a projected section,
a first buffer layer that is formed on the thin film substrate and the first optical waveguide, and
a signal electrode and a pair of ground electrodes that are disposed on a DC side, that are formed on the first buffer layer, and that apply a voltage to the first optical waveguide,
each of the signal electrode and the ground electrodes disposed on the DC side covers the step portion of the first buffer layer formed on the side walls of the first optical waveguide,
the second optical adjustment unit includes
a second optical waveguide that is a projected section,
a second buffer layer that is formed on the thin film substrate and the second optical waveguide, and
a signal electrode and a pair of ground electrodes that are disposed on a RF side, that are formed on the second buffer layer, and that apply a voltage to the second optical waveguide,
the signal electrode and the ground electrodes disposed on the RF side are separated from the step portion of the second buffer layer formed on the side walls of the second optical waveguide, and
a first thickness of the ground electrode disposed on the DC side is made thinner than a second thickness of the ground electrode disposed on the RF side.

7. The optical device according to claim 2, wherein a joining portion between the second optical waveguide included in the second optical adjustment unit and the first optical waveguide included in the first optical adjustment unit has a tapered structure such that the waveguide is gradually increased from the second optical waveguide included in the second optical adjustment unit toward the first optical waveguide included in the first optical adjustment unit.

8. An optical communication apparatus comprising:
a processor that executes signal processing on an electrical signal;
a light source that emits light; and
an optical device that modulates light emitted from the light source by using the electrical signal that is output from the processor, wherein
the optical device includes
an optical waveguide that is a projected section and that is disposed at a predetermined portion on a thin film substrate,
a buffer layer that is formed on the thin film substrate and the optical waveguide, and
an electrode that is formed on the buffer layer and that applies a voltage to the optical waveguide, and
the electrode covers a step portion of the buffer layer formed on side walls of the optical waveguide.

9. A method of manufacturing an optical device comprising:
forming an optical waveguide that is a projected section and that is disposed at a predetermined portion on a thin film substrate formed on a support substrate;
forming a step portion on a buffer layer that covers side walls of the optical waveguide corresponding to the projected section by laminating the buffer layer on the thin film substrate and the optical waveguide; and
forming an electrode on the buffer layer by performing a plating process after forming a resist for exposing a part of the step portion disposed on the buffer layer.
